(19) United States
(12) Patent Application Publication
(10) Pub. No.: US 2026/0326376 A1
(43) Pub. Date: Oct. 22, 2026

(54) INCORPORATION OF A FUSED DEPOSITION MODELING (FDM) PRINT HEAD INTO A HYBRID DEVICE AND METHOD FOR THE REINFORCEMENT OF POLYMER FIBER TEXTILES OR HYDROGEL STRUCTURES RENDERED BY MELT ELECTRO WRITING, ELECTROSPINNING, STANDARD BIOPRINTING, CHAOTIC BIOPRINTING, OR FDM ALONE

(71) Applicant: Ohio State Innovation Foundation, Columbus, OH (US)

(72) Inventors: David Dean, Columbus, OH (US); Ciro Rodriguez, Columbus, OH (US); Javier Vazquez Armendariz, Columbus, OH (US)

(21) Appl. No.: 19/651,199

(22) Filed: Apr. 17, 2026

Related U.S. Application Data
(60) Provisional application No. 63/790,833, filed on Apr. 18, 2025.

(51) Int. Cl. B29C 64/336; B29C 64/118; B29C 64/209; B29C 64/393; B33Y 10/00; B33Y 30/00; B33Y 50/02; B33Y 70/10; B29K 67/00; B29K 105/00

(52) U.S. Cl. CPC B29C 64/336; B29C 64/118; B29C 64/209; B29C 64/393; B33Y 10/00; B33Y 30/00; B33Y 50/02; B33Y 70/10; B29K 2067/04; B29K 2105/0005

(57) ABSTRACT

A hybrid printhead apparatus and method for additive manufacturing that integrates Melt Electrowriting, Fused Deposition Modeling, and Electrospinning into a single device is provided. The disclosed embodiments utilize parallel, independently controlled linear guides to deposit delicate, high precision polymer fibers, and subsequently reinforcing them with thicker macroscale fibers. This hybrid method preserves the structural integrity of the delicate underlying meshes despite varying processing temperatures. Furthermore, the disclosed embodiments enable the incorporation of bioactive compounds, such as those derived from Opuntia ficus-indica. By altering the physical pore size of the underlying framework, the disclosed embodiments provide tunable, sustained release kinetics for advanced tissue engineering and chronic wound care.

### CROSS-REFERENCE TO RELATED APPLICATIONS

This application claims priority to, and benefit of, U.S. Provisional Patent Application Serial Number 63,790,833, entitled “INCORPORATION OF A FUSED DEPOSITION MODELING (FDM) PRINT HEAD INTO A HYBRID DEVICE AND METHOD FOR THE REINFORCEMENT OF POLYMER FIBER TEXTILES OR HYDROGEL STRUCTURES RENDERED BY MELT ELECTROWRITING, ELECTROSPINNING, STANDARD BIOPRINTING, CHAOTIC BIOPRINTING, OR FDM ALONE”, filed on Apr. 18, 2025. The contents of which are hereby incorporated by reference.

### GOVERNMENT SUPPORT CLAUSE

This invention was made with government support under 2133630 awarded by the National Science Foundation. The government has certain rights in the invention.

### BACKGROUND

Additive manufacturing has significantly advanced biomedical engineering by allowing the creation of highly customized and complex three-dimensional structures. This field utilizes the layer-by-layer deposition of materials to build scaffolds intended to support cell growth and tissue regeneration. Common additive manufacturing techniques employed in biomedical applications include stereolithography, selective laser sintering, direct ink writing, melt electrowriting, electrospinning, and fused deposition modeling.

Each of these conventional techniques possesses distinct advantages but also significant inherent limitations. Melt electrowriting is a high precision method employing an electric field to deposit molten polymer fibers, creating microscale scaffolds with high porosity. However, melt electrowriting is restricted by a narrow range of processable polymers that require precise rheological properties, and it suffers from relatively slow fabrication speeds that hinder large scale production. Additionally, the resulting melt electrowriting fibers are highly delicate and easily broken during physical handling, such as removal from a print bed or transfer for cell seeding. Electrospinning utilizes an electrostatic field to produce ultrafine fibers from polymer solutions, yielding scaffolds with high surface area to volume ratios. Despite successfully mimicking the extracellular matrix, electrospun scaffolds frequently lack the necessary mechanical strength for load bearing applications. Furthermore, electrospinning provides limited control over fiber alignment and presents difficulties when attempting to fabricate thick structures. Conversely, fused deposition modeling extrudes thermoplastic filaments to construct macroscale scaffolds with high mechanical strength. The primary deficiencies of fused deposition modeling are its relatively low resolution, the production of excessively large fiber diameters that limit cell infiltration, and the difficulty of achieving high porosity.

Researchers have attempted to integrate these individual techniques into hybrid manufacturing processes to leverage their complementary strengths. For example, integrating melt electrowriting with electrospinning aims to pair mechanical stability with a biomimetic architecture. Similarly, combining fused deposition modeling with melt electrowriting attempts to merge macroscale mechanical integrity with intricate microscale porosity. Unfortunately, current hybrid manufacturing approaches are often plagued by structural inconsistencies and limited scalability. These failures are largely due to the challenges of managing differing processing temperatures, material incompatibilities, and poor interfacial adhesion between the distinct fiber types.

These manufacturing limitations directly impede the development of effective clinical therapies, particularly in tissue engineering and chronic wound care. A major persistent challenge is the inability to consistently manufacture tissue scaffolds that possess both intricate microscale biological functionality and sufficient macroscopic mechanical strength for practical handling and surgical suturing. Furthermore, while there is a recognized need to incorporate localized, controlled release mechanisms for therapeutic agents within wound dressings, existing scaffolds struggle to effectively retain and sustain the release of bioactive compounds without compromising the underlying structural integrity of the device. Consequently, the field requires advanced manufacturing strategies capable of overcoming the thermal, mechanical, and structural deficiencies of current additive manufacturing technologies.

### SUMMARY

A hybrid printhead apparatus for additive manufacturing is provided that integrates a Melt Electrowriting (MEW) printhead and a Fused Deposition Modeling (FDM) printhead is provided. The apparatus uses parallel linear guides driven by stepper motors to independently move the MEW and FDM printheads. A controller software independently manages the motion of the guides and the distinct melting temperatures used by the MEW polymer pellet feed and the FDM polymer filament feed. The MEW printhead includes electric heaters, a pneumatic extrusion system, and a high-voltage power supply to apply an electric field to a positively charged nozzle, depositing fine polymer fibers between 5 and 50 micrometers in diameter onto a grounded platform. The FDM printhead deposits thicker reinforcing fibers between 150 and 500 micrometers in diameter. The apparatus can also incorporate an electrospinning (ESP) printhead to deposit an electrospun polymer mesh. This system allows different fiber types to be layered using the same base thermoplastic material without the FDM extrusion thermally or structurally damaging the delicate MEW fibers.

A method for creating a mechanically reinforced hybrid scaffold is provided. The method involves melting a polymer pellet feed and depositing a base assembly of delicate MEW fibers. An ESP polymer mesh is then deposited onto this base. This ESP mesh incorporates bioactive compounds, such as flavonoids, polyphenols, and polysaccharides, derived from Opuntia ficus-indica (OFI) flour. Next, a polymer filament feed is melted, and a structural enclosure of thicker FDM fibers is deposited around or onto the MEW and ESP layers. This FDM enclosure provides sufficient mechanical strength to allow the scaffold to be physically handled without breaking and surgically sutured to adjacent tissue. The method also allows for the tunable release of the OFI bioactive compounds by altering the physical pore size of the underlying MEW base. This structurally reinforced FDM envelope can also be used to house bioprinted or chaotic printed hydrogel element.

### CLAIM SUMMARIES GO HERE when clams are finalized

The disclosed systems and methods provide many advantages over the prior art. One advantage of the disclosed system is its ability to provide substantial mechanical reinforcement to otherwise fragile microscale structures. Prior art techniques such as melt electrowriting and electrospinning produce highly delicate fibers that are easily broken during physical handling, removal from a print bed, or transfer for cell seeding. Electrospun scaffolds also frequently lack the necessary mechanical strength for load bearing applications. The disclosed apparatus overcomes these deficiencies by precisely integrating these delicate microscale fibers with significantly thicker and stronger macroscale fibers deposited via fused deposition modeling. This structural enclosure provides the necessary mechanical strength to allow the resulting hybrid scaffold to be safely handled, placed under physical load, and even surgically sutured to adjacent tissue.

Another advantage of the disclosed printhead is its capacity to layer distinct manufacturing processes without causing structural or thermal degradation. Previous attempts to create hybrid scaffolds have often failed due to structural inconsistencies caused by differences in processing temperatures, material compatibility, and poor interfacial adhesion between different fiber types. The disclosed methods solve this problem by utilizing an independently controlled hybrid printhead that safely deposits high temperature fused deposition modeling fibers directly onto delicate melt electrowritten and electrospun meshes. Because the system can utilize the same base thermoplastic material across all integrated techniques, the thick macroscale fibers do not thermally melt or structurally damage the underlying microscale framework.

Another advantage of the disclosed system is advanced control over the release kinetics of therapeutic agents compared to conventional wound dressings. While prior scaffolds struggle to effectively retain and sustain the release of bioactive compounds without compromising structural integrity, the disclosed methods utilize the precise architecture of the melt electrowritten base to physically modulate drug delivery. By selectively decreasing the pore size of the underlying polymer framework, the system creates a denser distribution and enhanced structural confinement of incorporated bioactive solids. This architectural control forces a more prolonged and sustained diffusion of the therapeutic compounds, offering a highly tailored approach for personalized chronic wound care and tissue regeneration.

Another advantage of the disclosed apparatus is its versatility, enabling the creation of robust structural envelopes that can house various secondary biomedical elements. Conventional additive manufacturing methods lack the ability to simultaneously construct a protective macroscale mesh and a biofunctional microscale interior within a single automated process. The hybrid structures produced by the disclosed printhead can uniquely serve as protective housings for delicate bioprinted or chaotic printed hydrogels. Additionally, these reinforced meshes can be adapted to function as barrier membranes or tissue sealing implants, such as hernia meshes, thereby broadening the clinical applicability of the fabricated devices.

### BRIEF DESCRIPTION OF THE DRAWINGS

The components in the drawings are not necessarily to scale relative to each other. Like reference numerals designate corresponding parts throughout the several views.

FIG. 1 illustrates a high-level system diagram of a hybrid printhead apparatus 100 in accordance with some embodiments of the present disclosure.

FIG. 2 illustrates detailed views of a hybrid scaffold architecture fabricated using the disclosed systems and methods.

FIG. 3 illustrates the sequential stages for fabricating the hybrid scaffold.

FIG. 4 is a flowchart illustrating a method for fabricating a mechanically reinforced hybrid scaffold in accordance with the present disclosure.

FIG. 5 illustrates an example computing device.

### DETAILED DESCRIPTION

The following detailed description provides comprehensive examples of the disclosed apparatus, systems, and methods. It is to be understood that the disclosed embodiments are merely exemplary and can be embodied in various and alternative forms.

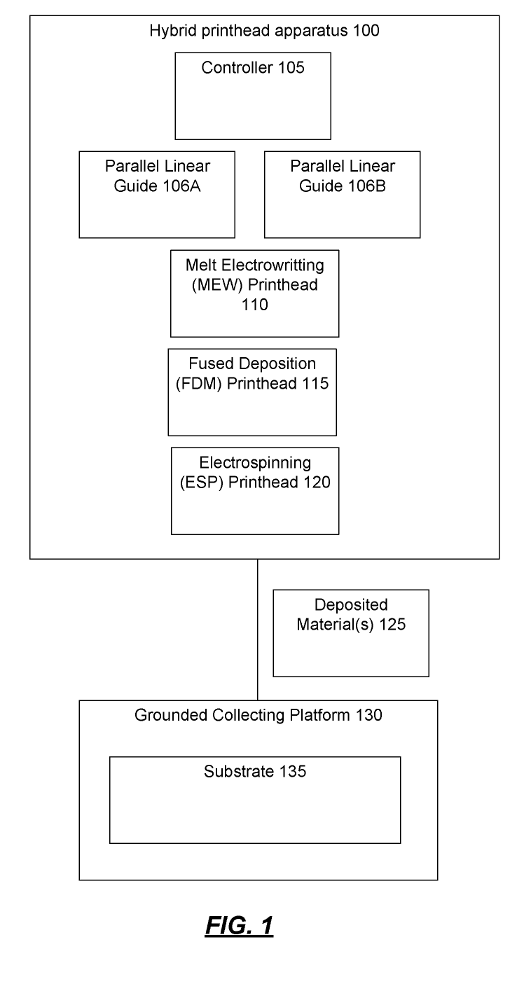

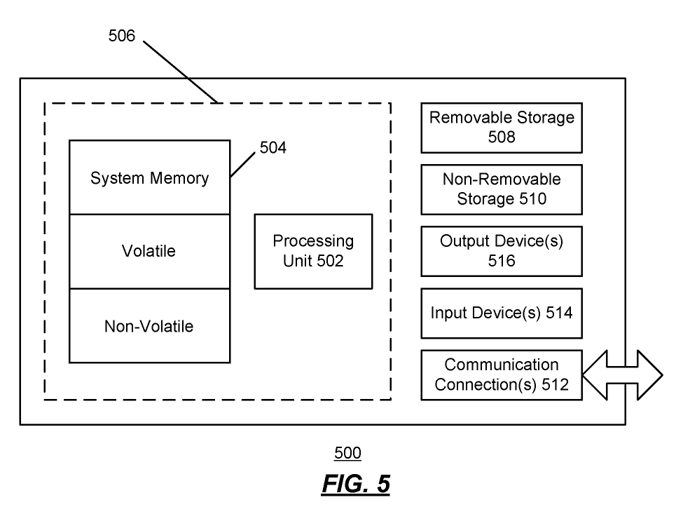

FIG. 1 illustrates a high level system diagram of a hybrid printhead apparatus 100 in accordance with some embodiments of the present disclosure. The hybrid printhead apparatus 100 integrates multiple additive manufacturing technologies into a single customized device. The apparatus 100 includes a controller 105 configured to manage the operations of the various components. In some embodiments, the controller 105 comprises an Arduino controller running customized software applications, such as an application designed in LabVIEW provided by National Instruments based in Austin Texas. A suitable controller 105 includes the computing device 500 illustrated with respect to FIG. 5.

The controller 105 may be communicatively coupled to a first parallel linear guide 106A and a second parallel linear guide 106B. More or fewer guides may be supported.

The parallel linear guides 106A and 106B provide independent linear vertical motion along a Z axis to the attached printheads (i.e., the printheads 110, 115, and 120). In some embodiments, the linear guides 106A and 106B are driven by NEMA 17 stepper motors and may comprise high precision components like ECO115SL linear guides from Aerotech. Other types of motors may be supported.

A melt electrowriting (MEW) printhead 110 is attached to the first parallel linear guide 106A. The melt electrowriting printhead 110 is configured to extrude molten polymer fibers to create microscale scaffolds with high porosity.

In some embodiments, the melt electrowriting printhead 110 includes components such as proportional integral derivative controlled electric heaters for melting a polymer pellet stock feed, a pneumatic extrusion system featuring an 8 gallon ultra quiet oil free air compressor from California Air Tools, a Cordis proportional valve from Clippard, and a positively charged nozzle. More or fewer components may be supported by the printhead 110.

A fused deposition modeling printhead 115 is attached to the second parallel linear guide 106B. The fused deposition modeling printhead 115 relies on the layer-by-layer extrusion of thermoplastic filaments to create macroscale scaffolds and structural enclosures.

In some embodiments, the fused deposition modeling printhead 115 comprises an adapted Ender Pro extruder or a Sprite Pro extruder manufactured by Creality in Shenzhen China. Other printheads may be supported.

The controller 105 independently manages the linear motion of the melt electrowriting printhead 110 and the fused deposition modeling printhead 115 on the linear guides 106. Furthermore, the controller 105 individually controls the distinct melting temperatures used by a polymer pellet stock feed of the melt electrowriting printhead 110 and a polymer filament stock feed of the fused deposition modeling printhead 115. Suitable temperature ranges include . Other temperature ranges may be supported.

The hybrid printhead apparatus 100 may further comprise an electrospinning printhead 120. The electrospinning printhead 120 uses an electrostatic field to draw polymer solutions into ultrafine fibers, producing meshes with a high surface area to volume ratio.

The apparatus 100 deposits materials 125 via the printheads 110, 115, or 120 onto a substrate 135, which is supported by a grounded collecting platform 130. In some embodiments, the substrate 135 is a 75 by 50 millimeter glass slide having a thickness of 1 millimeter. Other substrates 135 and sized slides may be used.

The grounded collecting platform 130 may work in conjunction with a high voltage power supply, such as an ESP20P 5W power supply from Gamma Research, connected to the melt electrowriting printhead 110 and the electrospinning printhead 120 to create the necessary electric fields for the precise deposition of materials 125. Other power supplies may be supported.

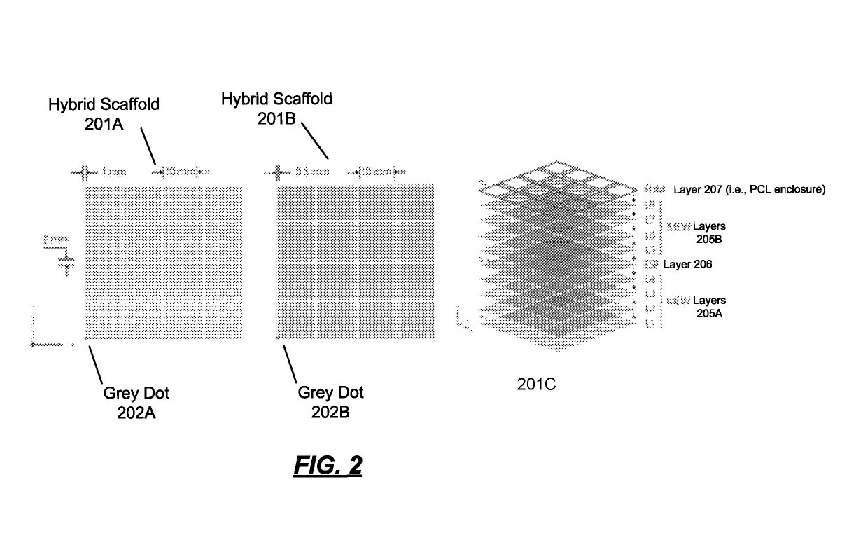

FIG. 2 illustrates detailed views of a hybrid scaffold 200 fabricated using the disclosed systems and methods. The design of the hybrid scaffolds 200 (i.e., the scaffolds 201A, 201B, and 201C) can feature varying pore sizes to control the properties of the final structure. In some embodiments, toolpath post processing and digital twin modeling are performed using the Fusion 360 software platform from Autodesk. For example, a top view of a scaffold having a 1 millimeter stepover distance, which determines the inter-fiber spacing, is shown in one embodiment. Alternatively, a top view of a scaffold having a 0.5 millimeter stepover distance is shown in another embodiment. These different pore sizes, such as 1000 micrometers and 500 micrometers, can be utilized to physically modulate the retention and release kinetics of integrated bioactive compounds. In some embodiments, up to 16 individual scaffolds measuring 10 by 10 millimeters can be fabricated in a single print batch, with a 2 millimeter gap left between each scaffold to facilitate cutting with a scalpel and removal from the collecting platform. An exploded view of the hybrid scaffold architecture reveals the layered integration of the distinct manufacturing technologies. The base of the scaffold features a base assembly of melt electrowritten fibers comprising four layers, specifically Layer 1, Layer 2, Layer 3, and Layer 4. Layer 1 is oriented along an X axis, representing a 0 degree layer. Layer 2 is overlaid along a Y axis, representing a 90 degree layer, to assemble a squared array. Layer 3 and Layer 4 follow the same dimensions and orientations to increase the overall strength of the base. An electrospun mesh is then deposited directly onto this melt electrowritten base. The electrospun mesh can incorporate bioactive compounds, such as Opuntia ficus indica flour combined with polycaprolactone. Four additional melt electrowritten layers, specifically Layer 5, Layer 6, Layer 7, and Layer 8, are subsequently deposited on top of the electrospun mesh to further reinforce the structure. Finally, a fused deposition modeling enclosure is added around the entire assembly to increase the overall stiffness of the individual hybrid scaffolds, thereby facilitating physical handling without destroying the inner delicate layers.

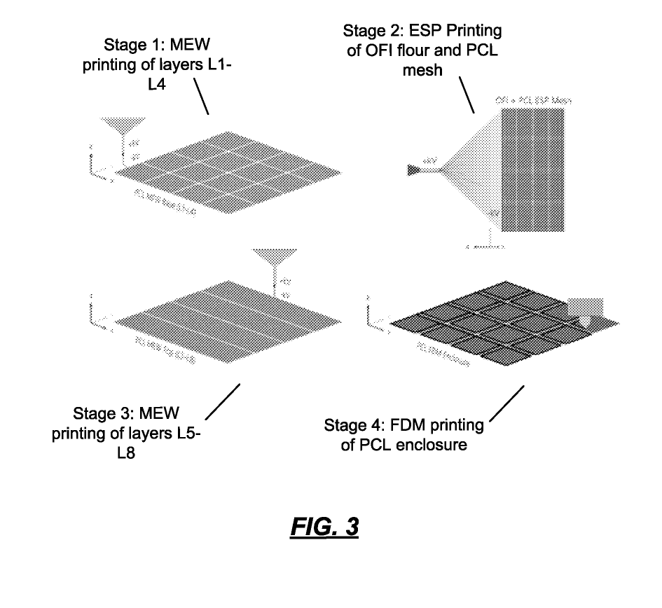

FIG. 3 illustrates the sequential stages for fabricating the hybrid scaffold 201. In stage 1, the melt electrowriting printhead 110 is utilized to deposit materials 125 comprising the polycaprolactone base of the scaffold 201, consisting of layers 1 through 4. During this stage, approximately 1 gram of polycaprolactone pellets with a molecular weight of 80,000 sourced from Polysciences are added to the melt electrowriting printhead 110 and melted for approximately one hour at 110 degrees Celsius. A G22 needle is used as the extrusion nozzle for the printhead 110. The system utilizes a critical translation speed of 22.5 millimeters per second, an extrusion pressure of 0.33 Bar, and a positive 5 kilovolt applied voltage. A constant height of 5 millimeters is maintained between the nozzle and the collecting substrate. These parameters, obtained through pre calibration, yield fine polymer fibers with a diameter ranging from 5 to 50 micrometers, and more specifically approximately 10 to 17 micrometers. The ambient temperature and relative humidity recorded during this stage can be 22 degrees Celsius and 16 percent, respectively. In stage 2, the electrospinning process deposits an Opuntia ficus indica and polycaprolactone mesh onto the previously printed base. The electrospinning solution is prepared by combining a 10 percent weight by volume solution of chloroform and polycaprolactone with a 30 percent weight by weight solution of chloroform and Opuntia ficus indica flour. Opuntia ficus indica is highly valued for its regenerative properties, as it contains bioactive flavonoids, polyphenols, and polysaccharides that exhibit antioxidant, anti inflammatory, and antimicrobial properties. The mixed solution is loaded into a 10 milliliter syringe secured in a horizontally oriented Fusion 200 syringe pump from Chemyx. A G18 needle is locked into the syringe and inserted into an acrylic box containing a 10 by 10 centimeter aluminum plate that is one eighth of an inch thick. This aluminum plate is vertically oriented at 15 centimeters away from the needle tip and electrically grounded. A voltage of 20 kilovolts is applied with a flow rate of 0.7 milliliters per minute for a duration of 5 minutes. The ambient temperature and relative humidity recorded during this stage can be 23 degrees Celsius and 18.7 percent, respectively. In stage 3, the glass slide is transferred back to the melt electrowriting machine, and the melt electrowriting printing process is used again to deposit the top reinforcing layers of the scaffold, consisting of layers 5 through 8. The parameters used in stage 3 are identical to those utilized in stage 1. In stage 4, the fused deposition modeling process prints a polycaprolactone structural enclosure. A 1.75 millimeter polycaprolactone filament from Uxcell is processed at a temperature of 70 degrees Celsius. An extrusion rate of 5 revolutions per minute and a print bed translation speed of 12.5 millimeters per second are used to obtain a robust fiber thickness ranging from 150 to 500 micrometers for the macroscale enclosure. Because the same base thermoplastic material is used, the thicker fused deposition modeling fibers do not thermally melt or structurally damage the underlying delicate melt electrowritten fibers or the electrospun mesh.

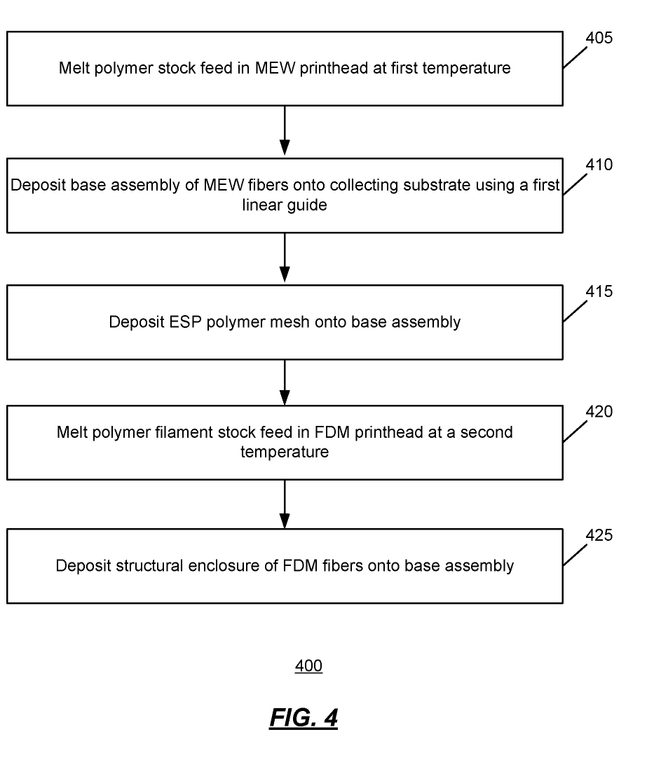

FIG. 4 is a flowchart illustrating a method for fabricating a mechanically reinforced hybrid scaffold in accordance with the present disclosure. At step 400, a polymer stock feed is melted in a melt electrowriting printhead at a first designated temperature, which may be 110 degrees Celsius when utilizing polycaprolactone pellets. At step 405, a base assembly of delicate melt electrowriting fibers is deposited onto a collecting substrate using a first linear guide. At step 425, an electrospun polymer mesh containing bioactive compounds, such as Opuntia ficus indica flour, is optionally deposited onto the base assembly. The pore size of the underlying base assembly can be selectively decreased from 1000 micrometers to 500 micrometers to create a denser structural confinement and force a more prolonged release of these bioactive compounds. At step 410, a polymer filament stock feed is melted in a fused deposition modeling printhead at a second designated temperature, which may be 70 degrees Celsius. At step 420, a structural enclosure of fused deposition modeling fibers is deposited onto or around the base assembly using an independently controlled parallel linear guide to provide substantial mechanical reinforcement.

In some alternative embodiments, the structural enclosure provided by the fused deposition modeling fibers can serve multiple vital biomedical purposes. For example, the robust macroscale structure permits the placement of physical loads to influence tissue development in culture or within the body. I t also provides sufficient mechanical strength to hold a surgical suture connecting the scaffold to adjacent biological tissue during implantation. In other embodiments, the fused deposition modeling structure acts as a cross cutting element to physically sew stacked textiles together, forming engineered tissue that is several layers thick. Furthermore, a fused deposition modeling mesh, or a combined melt electrowriting and fused deposition modeling mesh, can serve as a protective structural envelope for hydrogel based structures. These housed hydrogel elements can include standard bioprinted single stream filaments, bioprinted sheets, or complex micro channeled hydrogel elements produced via chaotic bioprinting techniques. The disclosed mechanically reinforced meshes can also be configured to function as barrier membranes or tissue sealing implants, such as a hernia mesh. Other compatible polymers that can be utilized within the disclosed systems include polylactic acid, polyether ether ketone, thermoplastic polyurethane, poly lactic co glycolic acid, and gelatin based composites.

FIG. 5 illustrates a block diagram of an exemplary computing environment 500 that can be utilized as the controller 105 for managing the disclosed hybrid printhead apparatus. The computing environment 500 includes a processing unit 502 configured to execute instructions and precisely manage both motion control and temperature regulation. The system utilizes system memory 504, which may include volatile memory 506 and non volatile memory 500. Data and customized software applications, such as the LabVIEW toolpaths and interface controls, can be stored on removable storage 508 or non removable storage 510. Communication connections 512 allow the controller to seamlessly interface with the NEMA 17 stepper motors, the pneumatic extrusion proportional valve, and the high voltage power supplies. Users can interact with the system via input devices 514 and receive diagnostic feedback through output devices 516.

What is claimed:

1. A hybrid printhead apparatus for additive manufacturing, comprising:
a first linear guide providing motion to a Melt Electrowriting (MEW) printhead configured to extrude a polymer pellet feed;
a second parallel linear guide providing motion to a Fused Deposition Modeling (FDM) printhead configured to extrude a polymer filament feed; and
a controller configured to independently control the linear motion of the first and second linear guides and to individually control distinct melting temperatures for the MEW and FDM printheads.

2. The apparatus of claim 1, wherein the first and second parallel linear guides are driven by stepper motors.

3. The apparatus of claim 1, wherein the controller uses software to individually control the motion and polymer stock feed temperatures of the MEW and FDM printheads.

4. The apparatus of claim 1, wherein the hybrid printhead apparatus is mounted on a linear Z-guide.

5. The apparatus of claim 1, wherein the MEW printhead further comprises proportional-integral-derivative (PID)-controlled electric heaters for material melting and a pneumatic system featuring an air compressor and proportional valve for extrusion pressure control.

6. The apparatus of claim 1, wherein the MEW printhead is electrically coupled to a high-voltage power supply to generate an electric field configured to deposit polymer fibers measuring between 5 and 50 micrometers in diameter.

7. The apparatus of claim 6, wherein the FDM printhead is configured to deposit reinforcing polymer fibers measuring between 150 and 500 micrometers in diameter to reinforce the MEW polymer fibers.

8. The apparatus of claim 1, further comprising an electrospinning (ESP) printhead incorporated into the apparatus to deposit an electrospun polymer fiber mesh.

9. The apparatus of claim 1, wherein the MEW printhead comprises a nozzle configured to receive a positive electrical charge, and the apparatus further comprises an electrically grounded collecting platform.

10. The apparatus of claim 1, wherein the hybrid printhead is configured to layer MEW fibers and FDM fibers utilizing a same base thermoplastic material without the FDM printhead structurally or thermally damaging the deposited MEW fibers.

11. A method for fabricating a mechanically reinforced hybrid scaffold using a hybrid printhead, the method comprising:
melting a polymer pellet stock feed in a Melt Electrowriting (MEW) printhead at a first temperature;
depositing a base assembly of MEW fibers onto a collecting substrate using a first linear guide;
melting a polymer filament stock feed in a Fused Deposition Modeling (FDM) printhead at a second temperature; and
depositing a structural enclosure of FDM fibers from the melted polymer filament stock onto or around the MEW fibers using a second linear guide, wherein the second guide is parallel to the first linear guide.

12. The method of claim 11, wherein the deposited MEW fibers have a diameter between 5 and 50 micrometers and the deposited FDM fibers have a diameter between 150 and 500 micrometers.

13. The method of claim 11, further comprising the step of depositing an electrospun (ESP) polymer mesh onto the base assembly of MEW fibers prior to depositing the structural enclosure of FDM fibers.

14. The method of claim 13, wherein the ESP polymer mesh incorporates bioactive compounds, comprising flavonoids, polyphenols, and polysaccharides, derived from Opuntia ficus-indica (OFI) flour.

15. The method of claim 14, further comprising the step of controlling a release profile of the bioactive compounds by altering a physical pore size of the base assembly of MEW fibers.

16. The method of claim 15, wherein decreasing the pore size of the base assembly of MEW fibers to 500 micrometers creates a denser distribution of OFI solids and forces a more prolonged and sustained release of the bioactive compounds compared to a MEW fiber pore size of 1000 micrometers.

17. The method of claim 11, wherein the MEW fibers and the FDM fibers comprise the same base polymer material, polycaprolactone (PCL).

18. The method of claim 11, wherein the deposited structural enclosure of FDM fibers provides sufficient mechanical reinforcement to the hybrid scaffold to permit physical handling without breakage and to allow surgical suturing to adjacent tissue.

19. The method of claim 11, wherein the structural enclosure of FDM fibers forms a structural envelope configured to house a bioprinted or chaotic printed hydrogel element.

20. The method of claim 11, wherein the step of depositing the base assembly of MEW fibers further comprises extruding the melted polymer pellet stock feed through a nozzle at a pressure of 0.33 Bar and applying an electric field of +5 kV to the nozzle.
